(19) United States
(12) Patent Application Publication
(10) Pub. No.: US 2004/0118024 A1
(43) Pub. Date: Jun. 24, 2004

(54) Decorative water ball

(76) Inventor: Chia-Ho Lei, Taoyean City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/327,131

(22) Filed: Dec. 24, 2002

(51) Int. Cl. G09F 19/00; G09F 13/00

(52) U.S. Cl. 40/409; 40/547

(57) ABSTRACT

The present invention relates to a decorative water ball, which includes a base being provided with a lighting source inside. A sealing cover is placed in the base to connect with bottom end of a transparent ball. Water can be fulfilled in the ball. A lot of lighting fibers are jointed at middle portion of the sealing cover and outer end of each lighting fiber is extended randomly in the transparent ball to emit the light from each outer terminal that obtains a special lighting effect.

### BACKGROUND OF THE INVENTION

A conventional decorative water ball includes a transparent glass ball and a base. There are decorations mounted on the base and water in the glass ball. Moreover, some reflexible pieces are put in the water for reflecting light during shaking the ball that provides a known decorative effect.

Accordingly, the primary object of the invention is to provide a decorative water ball, which is provided with lighting fibers in the ball to produce a special decorative lighting purpose by itself. Now the features and advantages of the present invention will be described in detail with reference to the accompanying drawings.

### BRIEF DESCRIPTION OF ACCOMPANYING DRAWINGS

FIG. 1 is a perspective view showing a decorative water ball according to the present invention.

FIG. 2 is a partly cross-sectional plan view of FIG. 1.

FIG. 3 is an exploded plan view of FIG. 2.

### DETAILED DESCRIPTION OF PREFERRED EMBODIMENTS

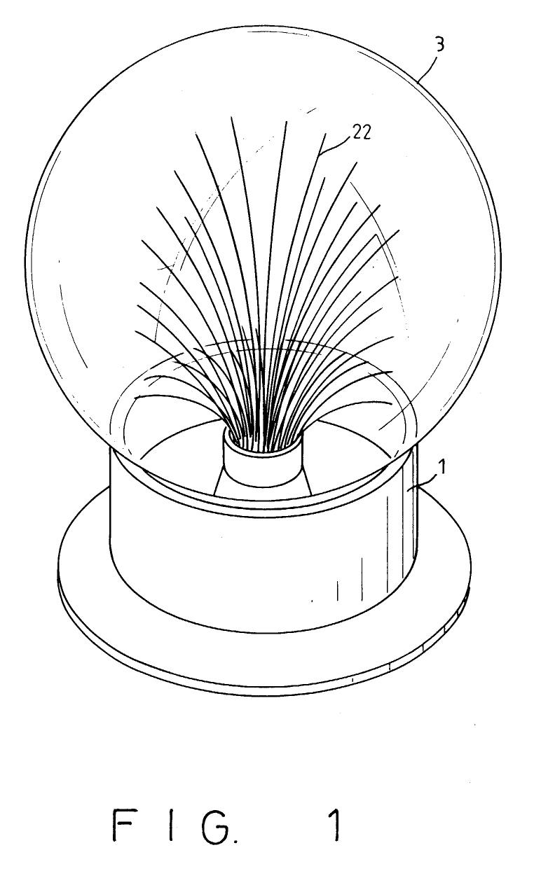

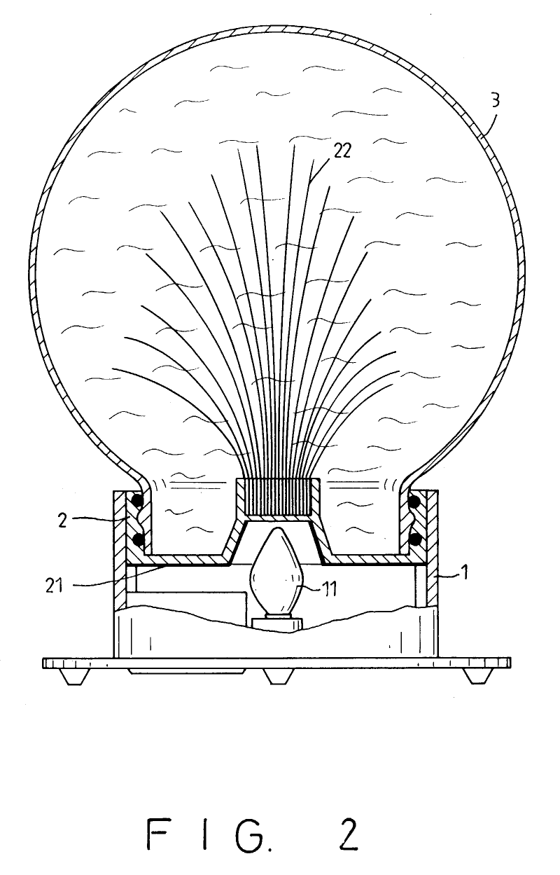

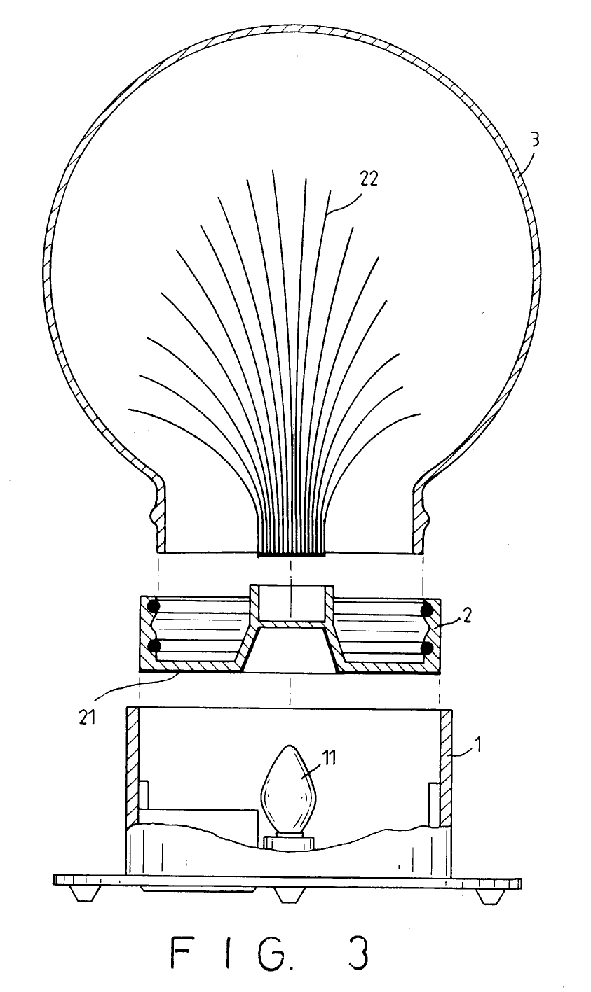

Please refer to FIG. 1 to 3, the present invention includes a base (1) being provided with a lighting source (11) inside. A sealing cover (2) is placed in the base (1) to connect with bottom end of a transparent ball (3). Water can be fulfilled in the ball (3). A lot of lighting fibers (22) are jointed at middle portion of the sealing cover (2) and outer end of each lighting fiber (22) is extended randomly in the transparent ball (3). A shield layer (21) is placed at bottom side of the cover (2) except the area where connecting with the lighting fibers (22). Hence, it can be understood that the light of the lighting source (11) can be transmitted only through the lighting fiber (22), which emits the light from each outer terminal that obtains a special lighting effect.

Above all, the present invention provides a novel structure to form lighting spots as a wonderful decoration. The lighting can be produced by itself and the water ball is unnecessary to be shaking.

Accordingly, the present invention obviously achieves utility and improvement and should be allowed for patent.

What is claimed is:

1. A decorative water ball including a base being provided with a lighting source inside, a sealing cover placed in the base to connect with bottom end of a transparent ball while water can be fulfilled in the ball; a lot of lighting fibers being jointed at middle portion of the sealing cover and outer end of each lighting fiber being extended randomly in the transparent ball, and a shield layer placed at bottom side of the cover except the area where connecting with the lighting fibers for that the light of the lighting source being transmitted only through the lighting fiber, which emits the light from each outer terminal.
